(19) United States
(12) Patent Application Publication
(10) Pub. No.: US 2018/0257289 A1
(43) Pub. Date: Sep. 13, 2018

(54) TEMPERATURE MEASUREMENT METHOD OF HONEYCOMB FORMED BODY, AND TEMPERATURE MEASUREMENT DEVICE

(71) Applicant: NGK INSULATORS, LTD., Nagoya-City (JP)

(72) Inventor: Takeshi TOKUNAGA, Nagoya-City (JP)

(73) Assignee: NGK INSULATORS, LTD., Nagoya-City (JP)

(21) Appl. No.: 15/902,199

(22) Filed: Feb. 22, 2018

(30) Foreign Application Priority Data
Mar. 8, 2017 (JP) 2017-044407

(51) Int. Cl. B29C 47/92; G01K 1/02; G01K 1/08

(52) U.S. Cl. CPC B29C 47/92; B29C 2947/92209; G01K 1/08; G01K 1/02

(57) ABSTRACT

A temperature measurement method of a honeycomb formed body including:

a temperature sensor attaching step of attaching a temperature sensor to the honeycomb formed body,

an introducing step of mounting, on a shelf plate, the honeycomb formed body to which the temperature sensor is attached, and a temperature measurement device which receives a sensor signal from the temperature sensor to acquire temperature information of the formed body temperature, and introducing the shelf plate on which the honeycomb formed body and the temperature measurement device are mounted, from the inlet into the firing space,

a temperature measuring step of acquiring the temperature information of an inner portion of the honeycomb formed body, by the temperature measurement device conveyed together with the honeycomb formed body, and

a collecting step of collecting the temperature sensor and the temperature measurement device from a take-out port.

“The present application is an application based on JP-2017-044407 filed on Mar. 8, 2017 with Japan Patent Office, the entire contents of which are incorporated herein by reference.”

### BACKGROUND OF THE INVENTION

### Field of the Invention

The present invention relates to a temperature measurement method of a honeycomb formed body, and a temperature measurement device, and more particularly, it relates to a temperature measurement method of a honeycomb formed body in which in a firing step of firing the honeycomb formed body, a formed body temperature of an inner portion of the honeycomb formed body to be conveyed in a firing kiln is accurately measured, and a temperature measurement device.

### Description of the Related Art

Heretofore, honeycomb structures made of ceramics have been used in various broad use applications to the car exhaust gas purifying catalyst carrier, a diesel particulate removing filter, a gasoline particulate removing filter, a heat reservoir for a burning device and the like. Here, the honeycomb structures made of ceramics (hereinafter referred to simply as “the honeycomb structures”) are manufactured by extruding honeycomb formed bodies through a die (or an extrusion die) by use of an extrusion device (an extrusion step) and then firing the honeycomb formed bodies at a high temperature by use of a firing kiln (a firing step). Consequently, there are obtainable the honeycomb structures including porous partition walls defining a plurality of cells which form through channels for a fluid and extend from one end face to the other end face.

In the firing step, each honeycomb formed body having one end face directed downward is mounted on a firing setter disposed on a shelf plate, and is introduced into the firing kiln, together with the shelf plate and the firing setter. Here, as the firing kiln, there is mainly used a continuous firing kiln (e.g., a tunnel kiln or the like) having a kiln space communicating between an inlet from which the honeycomb formed body and the like are introduced inside and an outlet from which the fired honeycomb formed body, i.e., the honeycomb fired body is discharged. Here the kiln space extending from the inlet to the outlet is adjusted at a predetermined kiln temperature, and the honeycomb formed body is fired while conveying the honeycomb formed body along a horizontal direction in the kiln space.

The kiln space is mainly dividable into a temperature rise region controlled so that its temperature reaches a firing temperature from the vicinity of room temperature, a firing region holding the firing temperature for a certain time, and a cooling region to cool the honeycomb fired body (the honeycomb structure) after the honeycomb formed body is fired, in accordance with a prescribed temperature rise curve. Here, in the honeycomb structure including cordierite as a main component, its firing temperature is set to a range of 1200° C. to 1500° C., and hence the above temperature rise region is also adjusted so that its temperature rises from the vicinity of room temperature to a high temperature at 1200° C. or more.

At this time, in the temperature rise region, a binder of an organic substance, carbide or the like included in the honeycomb formed body is heated and removed as the kiln temperature rises (a binder removing step). Then, the honeycomb formed body from which the binder is removed is fired at a high firing temperature (a main firing step).

Here, it is known that the binder is substantially removed at about 500° C. and that a product quality of the honeycomb fired body (the honeycomb structure) after the honeycomb formed body is fired is noticeably influenced by a heated state of the honeycomb formed body when the binder is removed in such a manner. In other words, defects such as “partition wall cracks” are occasionally generated in the partition walls of the honeycomb structure, depending on the heated state of the honeycomb formed body. Therefore, for the purpose of preventing the generation of the defects of the partition wall cracks and the like, it is especially required to acquire accurate temperature information concerned with a change of a formed body temperature of an inner portion of the honeycomb formed body with elapse of time up to about 500° C. in the kiln space.

To acquire the temperature information, for example, there is used an insulating container including a sealed container in which a temperature measurement device is stored, and a refrigerant such as ice or water to fill a periphery of the sealed container (e.g., see Patent Documents 1 to 3). In consequence, data (the temperature information) of a temperature and the like of a measuring target is acquired by utilizing a temperature sensor such as a thermocouple or the like extending from the temperature measurement device to the outside of the insulating container, a temperature change or the like during heating is measurable with elapse of time by use of the temperature measurement device protected in the insulating container, and the data can be stored and kept (an insulating container system).

Alternatively, when a honeycomb formed body, to which a thermocouple is set, is conveyed in a kiln space, the thermocouple is sent from an inlet, and the thermocouple sent out from the outlet is further collected and wound up (a thermocouple system). Consequently, temperature information from the thermocouple set to the honeycomb formed body is obtainable.

At this time, the thermocouple for use passes through the firing region disposed of after the temperature rise region, and hence to resist the high firing temperature, there is mainly used “an R-type thermocouple” in which a platinum-rhodium alloy is used. Furthermore, a plurality of thermocouples to measure the kiln temperature are occasionally arranged at predetermined intervals on an inner side of a kiln wall (e.g., in the vicinity of a ceiling) structuring the firing kiln.

[Patent Document 1] JP-A-2014-66633

[Patent Document 2] JP-A-2013-238624

[Patent Document 3] JP-A-2009-75076

### SUMMARY OF THE INVENTION

However, in the above-mentioned temperature measurement of a honeycomb formed body and the like in a firing kiln, such defects as described below occasionally occur. Specifically, in the temperature measurement by such an insulating container system as disclosed in each of Patent Documents 1 to 3, a heat capacity of a refrigerant to fill a periphery of a sealed container is small, and hence the system is not usable on firing conditions on which the honeycomb formed body is fired at a high temperature for a long time.

In the above insulating container system, when passing through a firing region at the high temperature, a temperature measurement device stored in the sealed container disposed of in an insulating container cannot sufficiently be protected from the high temperature, and there is a high possibility that the temperature measurement device is damaged. Therefore, when the insulating container is introduced into the firing kiln and then a temperature of the insulating container reaches the vicinity of 500° C. that is a kiln temperature at which a binder is completely removed, a conveying direction in the firing kiln is reversed, and an operation of collecting the insulating container from an inlet is performed. As a result, the measurement of the formed body temperature requires an operation of reciprocally conveying the insulating container in the kiln space, and hence a firing efficiency of the honeycomb formed body noticeably drops. In consequence, a manufacturing efficiency or productivity of a honeycomb structure might adversely be affected.

On the other hand, in a thermocouple system, a thermocouple needs to pass through the firing region at a high temperature after the thermocouple passes through a temperature rise region as described above. Therefore, it is necessary to use “an R-type thermocouple” in which a platinum-rhodium alloy more expensive than a usual thermocouple is used, and hence cost might increase for the measurement of the formed body temperature.

Furthermore, it is necessary to perform an operation of connecting at least one thermocouple between the inlet and an outlet, and sending out and winding up the thermocouple in accordance with a conveying speed of the honeycomb formed body. Specifically, in a firing step, operators need to be assigned at the inlet and the outlet, respectively, for the measurement of the formed body temperature, and large burdens might be imposed on the operators.

Additionally, when a twist or the like is generated in a part of the thermocouple while sending out and winding up the thermocouple, there is the possibility that temperature measurement is performed at a point other than an assumed measurement point, and the wrong measurement might be caused. Furthermore, for the purpose of sending out or winding up the thermocouple, it is necessary to increase a thickness of the thermocouple itself, or a member to protect the thermocouple (e.g., a bean insulator or the like) is required, and hence diameters of the thermocouple and the protective member occasionally increase more than necessary.

Consequently, the formed body temperature of the inner portion of the honeycomb formed body is not accurately measurable. Furthermore, even when the above countermeasure is employed, the R-type thermocouple or the like might be cut while sending out the thermocouple, because the strength of the R-type thermocouple or the like is not sufficient. Therefore, it has been difficult to measure the formed body temperature of the honeycomb formed body.

Alternatively, in a technology to measure a kiln temperature by a plurality of thermocouples arranged in the vicinity of a ceiling or the like of a firing kiln, regions to arrange the thermocouples are limited, the formed body temperature of the honeycomb formed body is not directly measured, and hence accurate temperature measurement is not achievable.

To solve the above problems, the present invention has been developed in view of the above actual situations, and objects thereof are to provide a temperature measurement method of a honeycomb formed body which is capable of accurately measuring a formed body temperature of an inner portion of the honeycomb formed body in a temperature rise region where the honeycomb formed body is heated up to a firing temperature, and to provide a temperature measurement device.

According to the present invention, there are provided a temperature measurement method of a honeycomb formed body, and a temperature measurement device as follows.

[1] A temperature measurement method of a honeycomb formed body in which a continuous firing kiln including a firing space constructed in an elongated tunnel shape and an inlet and an outlet each communicating with the firing space is utilized to measure a formed body temperature of the honeycomb formed body fired while being conveyed from the inlet toward the outlet, the temperature measurement method including a temperature sensor attaching step of attaching a temperature sensor to the honeycomb formed body that is a measuring target, an introducing step of mounting, on a shelf plate, the honeycomb formed body to which the temperature sensor is attached, and a temperature measurement device which receives a sensor signal from the temperature sensor to acquire temperature information of the formed body temperature, and introducing the shelf plate on which the honeycomb formed body and the temperature measurement device are mounted, from the inlet into the firing space, a temperature measuring step of acquiring the temperature information of an inner portion of the honeycomb formed body conveyed and fired in the firing space, by the temperature measurement device conveyed together with the honeycomb formed body, and a collecting step of collecting the temperature sensor and the temperature measurement device from a take-out port disposed in a middle of the firing space of the continuous firing kiln.

[2] The temperature measurement method of the honeycomb formed body according to the above [1], wherein the take-out port is disposed in a middle of a temperature rise region where a kiln temperature of the firing space is 500° C. or less.

[3] The temperature measurement method of the honeycomb. formed body according to the above [1] or [2], further including a temperature information extracting step of extracting the temperature information from the temperature measurement device collected in the collecting step.

[4] The temperature measurement method of the honeycomb formed body according to the above [1] or [2], wherein the temperature measurement device has a radio communication function of transmitting the acquired temperature information from the firing space to the outside of the continuous firing kiln, the temperature measurement method further including a temperature information receiving step of receiving the transmitted temperature information outside the continuous firing kiln.

[5] The temperature measurement method of the honeycomb formed body according to any one of the above [1] to [4], wherein the collecting step is performed in a state where the conveyance of the honeycomb formed body from the inlet toward the outlet is continued.

[6] The temperature measurement method of the honeycomb formed body according to any one of the above [1] to [5], wherein the temperature sensor is a K-type thermocouple.

[7] The temperature measurement method of the honeycomb formed body according to any one of the above [1] to [6], wherein the temperature sensor attaching step further includes a sensor insertion hole piercing step of piercing a sensor insertion hole into which the temperature sensor of the honeycomb formed body of the measuring target is to be inserted, and a temperature sensor inserting step of inserting the temperature sensor into the pierced sensor insertion hole and setting the temperature sensor so that a measurement point of the temperature sensor is positioned at the inner portion of the honeycomb formed body.

[8] The temperature measurement method of the honeycomb formed body according to the above [7], wherein in the sensor insertion hole piercing step, the sensor insertion hole is pierced to extend through an upper stage side honeycomb formed body of a stacked honeycomb formed body in which at least two honeycomb formed bodies are vertically stacked and to reach an inner portion of a lower stage side honeycomb formed body, and in the temperature sensor inserting step, the temperature sensor is set so that the temperature sensor passes through the sensor insertion hole of the upper stage side honeycomb formed body and so that the measurement point of the temperature sensor is positioned at the inner portion of the lower stage side honeycomb formed body.

[9] A temperature measurement device for use in the temperature measurement method of the honeycomb formed body according to any one of the above [1] to [8], including a temperature information recorder electrically connected to a temperature sensor attached to the honeycomb formed body of a measuring target, to receive a sensor signal from the temperature sensor and to acquire temperature information of a formed body temperature of the honeycomb formed body, a sealed container including a recorder storage space to store at least one temperature information recorder and configured to store the temperature information recorder in the recorder storage space while holding a liquid-tight state of the temperature information recorder, a vacuum insulating container including a sealed container storage space configured to store the sealed container, a refrigerant to fill a periphery of the sealed container stored in the sealed container storage space of the vacuum insulating container, and a fire-resistant insulating container made of a fire-resistant insulating material and having a vacuum insulating container storage space configured to store the vacuum insulating container.

[10] The temperature measurement device according to the above [9], wherein the temperature information recorder further has a radio communicating section which transmits the acquired temperature information.

According to a temperature measurement method of a honeycomb formed body of the present invention, a temperature measurement device which passes through a temperature rise region is collectable from a take-out port disposed in a middle of a firing kiln. Consequently, it is not necessary to reversely convey the temperature measurement device, and productivity of a honeycomb structure does not deteriorate. In particular, a conveying speed of the honeycomb formed body to be conveyed in the firing kiln is comparatively moderate, and hence the temperature measurement device is collectable without stopping the conveyance of the honeycomb formed body.

Furthermore, the temperature measurement device does not pass through a high-temperature firing region disposed after the temperature rise region, and hence an expensive R-type thermocouple does not have to be used as a thermocouple. For example, a K-type thermocouple is usable in which a comparatively inexpensive alumel (registered trademark)-chromel (registered trademark) alloy is used. As a result, it is possible to decrease a diameter of the thermocouple itself, and it is possible to decrease a thickness of a protective member to protect the thermocouple from the high temperature. Consequently, a formed body temperature of an inner portion of the honeycomb formed body is directly and accurately measurable without being disturbed by the protective member.

### BRIEF DESCRIPTION OF THE DRAWINGS

FIG. 1 is an explanatory view schematically showing an outline structure of a temperature measurement method of a honeycomb formed body of the present embodiment;

FIG. 2 is an explanatory view schematically showing an attaching example of a temperature sensor to be attached to the honeycomb formed body;

FIG. 3 is an explanatory view schematically showing an attaching example of the temperature sensor to be attached to a stacked honeycomb formed body;

FIG. 4 is an explanatory view schematically showing one example of arrangement of honeycomb formed bodies of measuring targets and a temperature measurement device which are to be introduced into a firing kiln;

FIG. 5 is a perspective view showing a schematic structure of the temperature measurement device of the present embodiment; and

FIG. 6 is a perspective view showing a schematic structure of temperature information recorders in the temperature measurement device, and a sealed container.

### DESCRIPTION OF THE PREFERRED EMBODIMENTS

Hereinafter, descriptions will be made as to embodiments of a temperature measurement method of a honeycomb formed body of the present invention, and a temperature measurement device with reference to the drawings, respectively. The temperature measurement method of the honeycomb formed body of the present invention, and the temperature measurement device are not limited to the following embodiments, and changes, modifications, improvements and the like are addable without departing from the gist of the present invention.

1. Structure of Continuous Firing Kiln

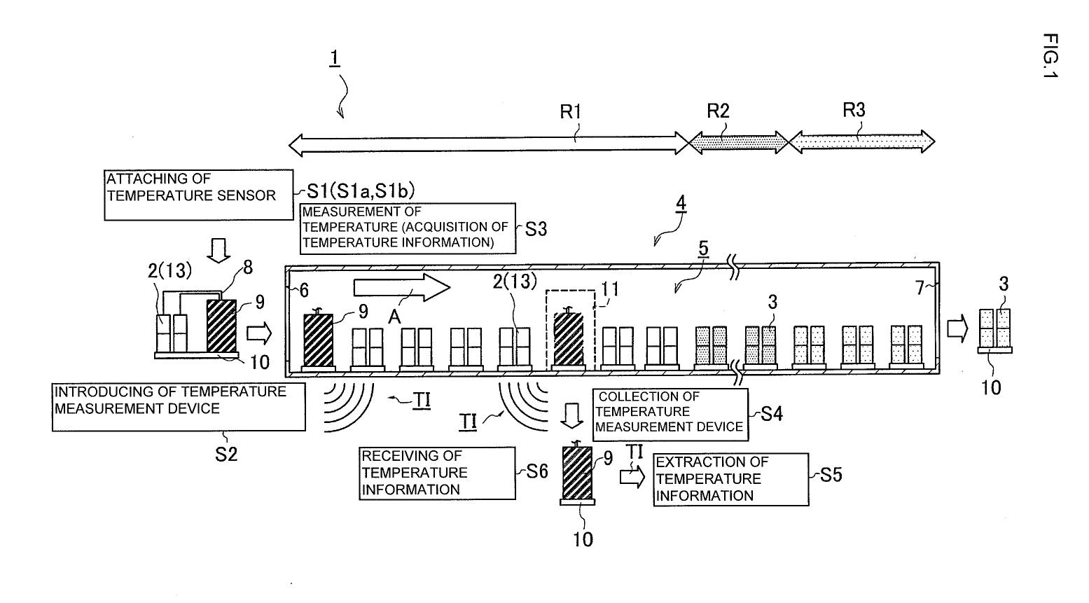

A temperature measurement method 1 of a honeycomb formed body of one embodiment of the present invention (hereinafter referred to simply as “the temperature measurement method 1”) is performed in a firing step of firing a honeycomb formed body 2 at a high firing temperature, and forming a honeycomb fired body 3 (or a honeycomb structure). Here, the firing step is performed by using such a continuous firing kiln 4 as shown in FIG. 1.

The continuous firing kiln 4 includes an elongated tunnel-shaped firing space 5 (a kiln space) formed therein, and an inlet 6 and an outlet 7 which communicate with the firing space 5. It is to be noted that openable/closable doors (not shown) are disposed in the inlet 6 and the outlet 7, respectively, and a communicating state between the outside of the continuous firing kiln 4 and the firing space 5 is controllable by an opening/closing operation of the doors.

In the continuous firing kiln 4, by use of a well-known conveyance means disposed of in the firing space 5, the honeycomb formed body 2 is conveyable from the inlet 6 toward the outlet 7 along a conveying direction A which matches a horizontal direction (see FIG. 1). Additionally, FIG. 1 shows that the inlet 6 and the outlet 7 are linearly positioned, but the present invention is not limited to this example, and the shape of the elongated tunnel-shaped firing space 5 may not only be linearly structured, but also include a curved region, a perpendicular region, or the like in a part thereof.

Here, the firing space 5 of the continuous firing kiln 4 is mainly dividable into three regions R1, R2 and R3 as shown in FIG. 1. That is, the firing space is mainly divided into a region (a temperature rise region R1) where a kiln temperature is raised from a temperature in the vicinity of room temperature of the vicinity of the inlet 6 to reach a firing temperature of 1200° C. or more, to fire the honeycomb formed body 2 at the high temperature, a region (a firing region R2) where the kiln temperature which has reached the firing temperature is held for a certain time, to fire the honeycomb formed body 2, and a cooling region R3 where the honeycomb fired body 3 which has passed through the firing region R2 and has completely been fired is cooled down to a dischargeable temperature to discharge the honeycomb fired body from the outlet 7 of the continuous firing kiln 4.

In the continuous firing kiln 4, a kiln wall of a fire-resistant material is used, thereby constructing the elongated tunnel-shaped firing space 5 in the kiln. Furthermore, in the inlet 6 and the outlet 7, the openable/closable doors (not shown) are disposed to shield a space between the firing space 5 and the outside of the continuous firing kiln 4. On the other hand, a take-out port 11 is disposed in a part of a side wall of the continuous firing kiln 4 which is positioned in a middle of the temperature rise region R1.

In the take-out port 11, an openable/closable door (or a lid) is disposed of in the same manner as in the inlet 6 or the like mentioned above. In particular, the take-out port 11 is disposed of in a region where the kiln temperature is 500° C. or less in the temperature rise region R1. The take-out port 11 can communicate between the firing space 5 of the temperature rise region R1 and the outside of the continuous firing kiln 4, and a member such as an after-mentioned temperature measurement device 9 can be taken out (collected) from the firing space 5.

2. Temperature Measurement Method of Honeycomb Formed Body

The temperature measurement method 1 of the present embodiment is performed in the firing step of the honeycomb formed body 2 by use of the continuous firing kiln 4, and mainly includes a temperature sensor attaching step S1 of attaching a temperature sensor 8 such as a thermocouple to the honeycomb formed body 2 of a measuring target, an introducing step S2 of mounting, on a shelf plate 10, the honeycomb formed body 2 to which the temperature sensor 8 is attached and the temperature measurement device 9 connected to the temperature sensor 8 together with a honeycomb formed body 2a of a firing target, and introducing the shelf plate on which the honeycomb formed bodies and the temperature measurement device are mounted, into the firing space 5, a temperature measuring step S3 of acquiring temperature information TI of an inner portion of the honeycomb formed body 2 introduced inside from the inlet 6 and fired while being conveyed in the firing space 5, together with its change with elapse of time by the temperature measurement device 9, and a collecting step S4 of collecting the temperature sensor 8 and the temperature measurement device 9 from the take-out port 11 disposed in a middle of the firing space 5 of the continuous firing kiln 4.

Furthermore, in addition to the above structure, the temperature measurement method 1 of the present embodiment may include a temperature information extracting step S5 of extracting the temperature information TI concerned with the formed body temperature of the inner portion of the honeycomb formed body 2 subjected to the firing step, from the temperature measurement device 9 collected in the collecting step S4. Consequently, the temperature information TI of the honeycomb formed body 2 which is acquired in the firing step is extracted and obtainable later. Various analyses and the like can be performed by utilizing the extracted temperature information TI. In consequence, the kiln temperature in the temperature rise region R1 can be raised with a temperature rise curve suitable for the firing of the honeycomb formed body 2.

On the other hand, a well-known radio communication function (e.g., WiFi (registered trademark) or Bluetooth (registered trademark)) may be imparted to the temperature measurement device 9, to directly acquire the temperature information TI from the temperature measurement device 9 which is being conveyed in the firing space 5. In this case, the temperature measurement device may have a function of receiving the temperature information TI transmitted from the firing space 5, by a temperature information receiver disposed outside the continuous firing kiln 4 (e.g., a personal computer, a tablet type terminal, a smartphone terminal or the like having the radio communication function, which is not shown) (a temperature information receiving step S6).

By use of such a temperature information receiver, it is possible to acquire the formed body temperature of the inner portion of the honeycomb formed body 2 or 2a in real time, and it is possible to display, for example, a graph or the like indicating the change of the temperature with the elapse of time after the honeycomb formed body is introduced inside from the inlet 6. As a result, it is possible to immediately grasp a temperature behavior of the honeycomb formed body 2 which is being conveyed in the continuous firing kiln 4.

2.1 Temperature Sensor Attaching Step S1

As the temperature sensor 8 for use in the temperature measurement method 1 of the present embodiment, a K-type thermocouple is especially preferably used in which an alumel (registered trademark) alloy and a chromel (registered trademark) alloy are used. In the K-type thermocouple, a usable temperature range is from −200° C. to 1000° C., and the thermocouple is broadly used in an industrial field. Consequently, the thermocouple is comparatively inexpensive among various thermocouples, and hence it is possible to suppress cost concerned with the temperature measurement. However, there is not prevented use of a thermocouple other than the above K-type thermocouple or a well-known temperature sensor other than the thermocouple, as the temperature sensor 8.

When the K-type thermocouple is used as the temperature sensor 8, a diameter of its electrode wire can be 1 mm or less (e.g., about 0.5 mm). Therefore, attaching properties to and detaching properties from the honeycomb formed body 2 are more excellent than those of a conventionally used thermocouple (an R-type thermocouple). Furthermore, a sensor insertion hole 12 (which will be described later in detail) to which the temperature sensor 8 is to be attached can comparatively easily be made, and a measurement point 8a can precisely be sent to a specific position of the inner portion of the honeycomb formed body 2.

Consequently, it is possible to precisely measure the temperature of the inner portion of the formed body, and accuracy of the temperature measurement improves. Additionally, when the K-type thermocouple having a smaller diameter and incurring lower cost is used as the temperature sensor 8, the temperature sensors 8 can be attached to a large number of honeycomb formed bodies 2 and/or a large number of positions of the honeycomb formed body 2, and when the temperature measurement method 1 is performed once, a large number of pieces of temperature information TI are collectively obtainable.

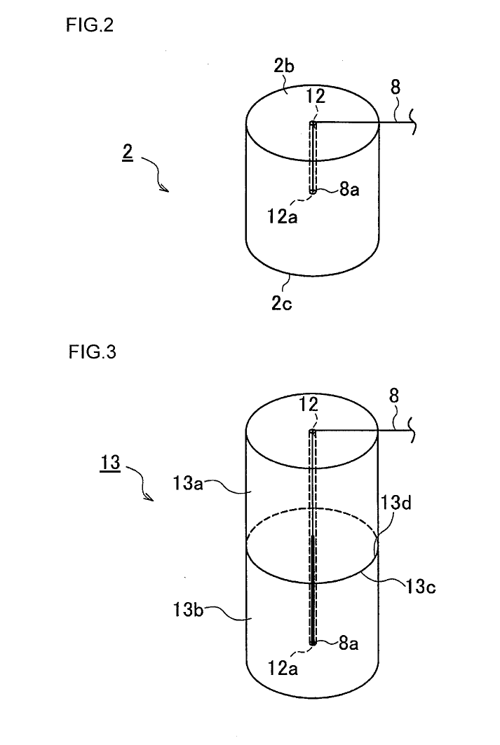

Hereinafter, description will specifically be made as to one example where the temperature sensor 8 is attached to the honeycomb formed body 2. For example, as shown in FIG. 2, the temperature sensor attaching step S1 further includes a sensor insertion hole piercing step S1a of piercing the sensor insertion hole 12 into which the temperature sensor 8 is to be inserted and attached, from one end face 2b of the honeycomb formed body 2 of the measuring target toward the other end face 2c thereof by use of a cutting means such as a drill in the inner portion of the honeycomb formed body 2, and a temperature sensor inserting step S1b of inserting the measurement point 8a of the temperature sensor 8 down to a hole end 12a of the sensor insertion hole 12 to set the temperature sensor to the pierced sensor insertion hole 12.

Here, a hole depth of the sensor insertion hole 12 is changed, so that the measurement point 8a of the temperature sensor 8 can be matched and attached to an optional position in the inner portion of the honeycomb formed body 2. FIG. 2 shows the example where the measurement point 8a of the temperature sensor 8 is positioned in a center of the inner portion of the honeycomb formed body 2. There are not any special restrictions on the position of the measurement point 8a of the temperature sensor 8, and the sensor insertion hole 12 may be made in the vicinity of a circumference of the honeycomb formed body 2 or in the vicinity of the end face of the honeycomb formed body. In consequence, it is possible to acquire the temperature information TI concerned with the formed body temperature at the optional position of the inner portion of the honeycomb formed body 2.

On the other hand, the temperature sensor attaching step S1 may be performed as follows. Here, in usual firing of the honeycomb formed body 2, a stacked honeycomb formed body 13 in which at least two honeycomb formed bodies 2 are vertically stacked is occasionally introduced into the firing space 5 of the continuous firing kiln 4 (see FIG. 1 and FIG. 3).

In this case, in the sensor insertion hole piercing step S1a, the sensor insertion hole 12 may be pierced to extend through an upper stage side honeycomb formed body 13a of the stacked honeycomb formed body 13 along a honeycomb axial direction and to reach an inner portion of a lower stage side honeycomb formed body 13b. Consequently, the temperature sensor 8 can be inserted from the upper stage side honeycomb formed body 13a of the stacked honeycomb formed body 13, and the measurement point 8a can be positioned at the inner portion of the lower stage side honeycomb formed body 13b.

In the temperature measurement method 1 of the present embodiment, as described above, a pair of honeycomb formed bodies 2 are vertically stacked in two stages and introduced into the firing space 5 as the stacked honeycomb formed body 13 in which one formed body end face 13d corresponding to an upper surface of the lower stage side honeycomb formed body 13b and the other formed body end face 13c corresponding to a lower surface of the upper stage side honeycomb formed body 13a abut on each other, and then the firing is performed. Additionally, in this example, one end of the temperature sensor 8 attached to the honeycomb formed body 2 is electrically connected to the temperature measurement device 9 (description will be made later as to a specific structure), and a sensor signal (not shown) detected by the temperature sensor 8 can be transmitted to the temperature measurement device 9.

2.2 Throwing Step S2

The honeycomb formed body 2 to which the temperature sensor 8 is attached as in the above 2.1 and the temperature measurement device 9 electrically connected to the temperature sensor 8 are mounted on the shelf plate 10. At this time, the temperature measurement device 9 is capable of measuring, in real time, the temperature information TI from a timing when time information is set to an initial set value and the temperature measurement device is mounted on the shelf plate 10 and introduced from the inlet 6 into the firing space 5.

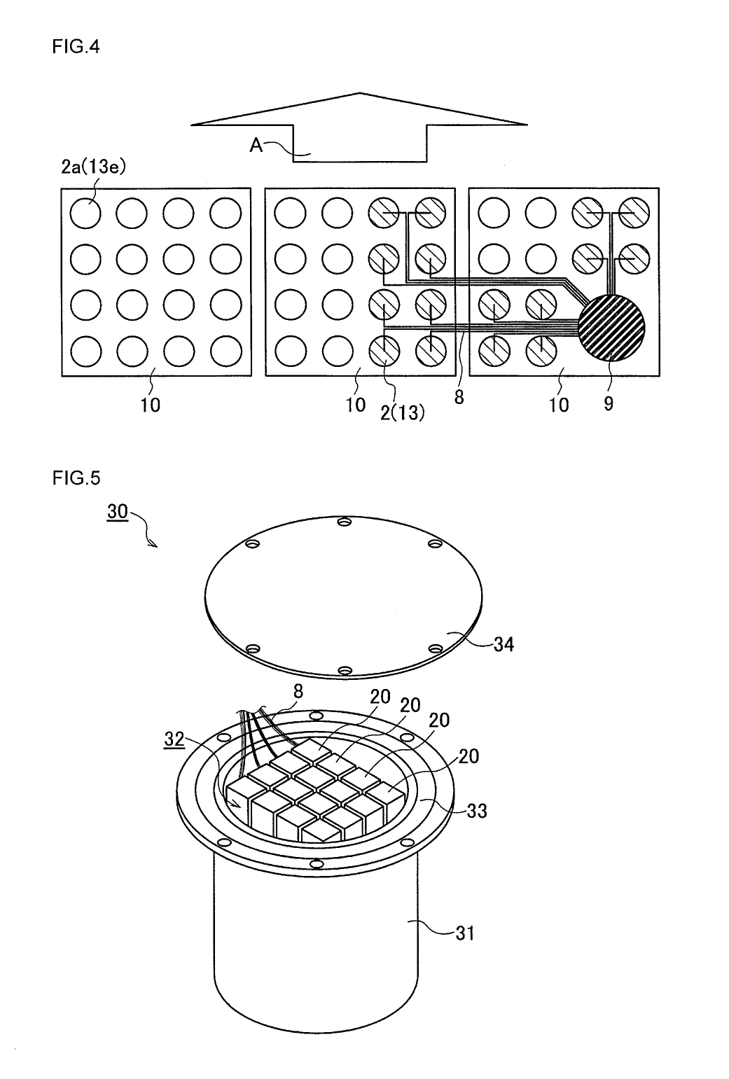

There are not any special restrictions on a mounting layout of the honeycomb formed bodies 2 and the temperature measurement device 9 on the shelf plate 10. FIG. 4 shows one example. Here, on the shelf plate 10, the honeycomb formed body 2a (or a stacked honeycomb formed body 13e) is also mounted to which the temperature sensor 8 is not attached and which is scheduled to be shipped as the honeycomb fired body 3 (the honeycomb structure) after the firing is completed. FIG. 4 shows each honeycomb formed body 2 (or each stacked honeycomb formed body 13) to which the temperature sensor 8 is attached, by hatching. In the temperature measurement method 1 of the present embodiment, for the purpose of collecting the temperature measurement device 9 from the take-out port 11, the temperature measurement device 9 is disposed at a right end position to the conveying direction A.

Additionally, the layout of the temperature measurement device 9 and the positions, the number and the like of the honeycomb formed bodies 2 of the measuring targets are not limited to those of FIG. 4. Alternatively, each of the honeycomb &limed bodies 2 and 2a and the stacked honeycomb formed bodies 13 and 13e may be mounted on “a firing setter” disposed on the shelf plate 10.

2.3 Temperature Measuring Step S3

The honeycomb formed bodies 2 and the temperature measurement device 9 mounted on the shelf plate 10 are introduced together with the honeycomb formed body 2a of the measuring target and the like from the inlet 6 into the firing space 5 (see the above introducing step S2). Then, the shelf plate is conveyed at a prescribed conveying speed along the conveying direction A. The firing space 5 is divided into the temperature rise region R1, the firing region R2, and the cooling region R3 as described above.

Therefore, the temperature of the inner portion of the formed body gradually rises with rise of the kiln temperature of the firing space 5, while the honeycomb formed body 2 and the like are slowly conveyed through the temperature rise region R1. Furthermore, with the rise of the formed body temperature, a binder in a forming material including the honeycomb formed body 2 is heated and removed. A fluctuation of the formed body temperature which accompanies the removal of the binder and the like is detected together with time information by the temperature sensor 8, and transmitted as the sensor signal to the temperature measurement device 9. On the other hand, on receiving the sensor signal transmitted from the temperature sensor 8, the temperature measurement device 9 records the sensor signal. It is to be noted that when the radio communication function is imparted to the temperature measurement device 9 as described above, the temperature measurement device may transmit the temperature information TI based on the received sensor signal toward the outside of the continuous firing kiln 4.

2.4 Collecting Step S4

As described above, the continuous firing kiln 4 has the take-out port 11 disposed in the middle of the temperature rise region R1 where the kiln temperature is 500° C. or less. Here, the binder or the like is mainly made of an organic substance or the like, and hence the binder or the like is heated and decomposed, and substantially removed at a temperature of 500° C. or less in atmospheric air. Therefore, even when the temperature information TI concerned with the formed body temperature is acquired at 500° C. or more, a behavior of the formed body temperature in the removal of the binder cannot be grasped. Furthermore, danger of an operation of collecting the temperature measurement device 9 heightens, or there is the possibility that the temperature measurement device 9 breaks due to an influence of the high temperature. Therefore, in the temperature measurement method 1 of the present embodiment, the take-out port 11 is disposed in the temperature rise region R1 where the binder or the like is completely removed at 500° C. or less.

A timing to collect the temperature measurement device 9 is determined on the basis of the time elapsed after the temperature measurement device is introduced inside from the inlet 6, the conveying speed, and a distance from the inlet 6 to the take-out port 11. When the temperature measurement device 9 is conveyed to the vicinity of the take-out port 11, the take-out port 11 usually closed with the door (or the lid) is opened, thereby achieving a state where the firing space 5 communicates with the outside of the continuous firing kiln 4. At this time, the conveying speed of the temperature measurement device 9 along the conveying direction A is very moderate, and hence, for example, a series of operation of opening the take-out port 11, collecting the temperature measurement device 9 and the like from the take-out port 11, and closing the take-out port 11 can be performed in a state where the conveyance of the honeycomb formed bodies 2 and 2a and the like is continued.

It is to be noted that when necessary, the conveyance of the honeycomb formed bodies 2 and 2a and the like may temporarily be stopped. At this time, to collect the temperature measurement device 9 and the like from the take-out port 11, there is usable a suspension apparatus such as a hoist crane movable along a horizontal direction in a state where a heavy load is suspended. In consequence, it is possible to safely collect the temperature measurement device 9 of the heavy load at the high temperature to the outside of the continuous firing kiln 4. Furthermore, the temperature sensor 8 is inserted from the upside of the honeycomb formed body 2 (or the stacked honeycomb formed body 13) into the sensor insertion hole 12 and set thereto. Therefore, when the temperature sensor 8 is lifted upward along the honeycomb axial direction of the honeycomb formed body 2 or the like, the attached state of the temperature sensor 8 can easily be eliminated. It is to be noted that there has already been described the extraction of the temperature information TI from the temperature measurement device 9 after the temperature measurement device is collected from the continuous firing kiln 4, or the like, and hence detailed description is omitted here.

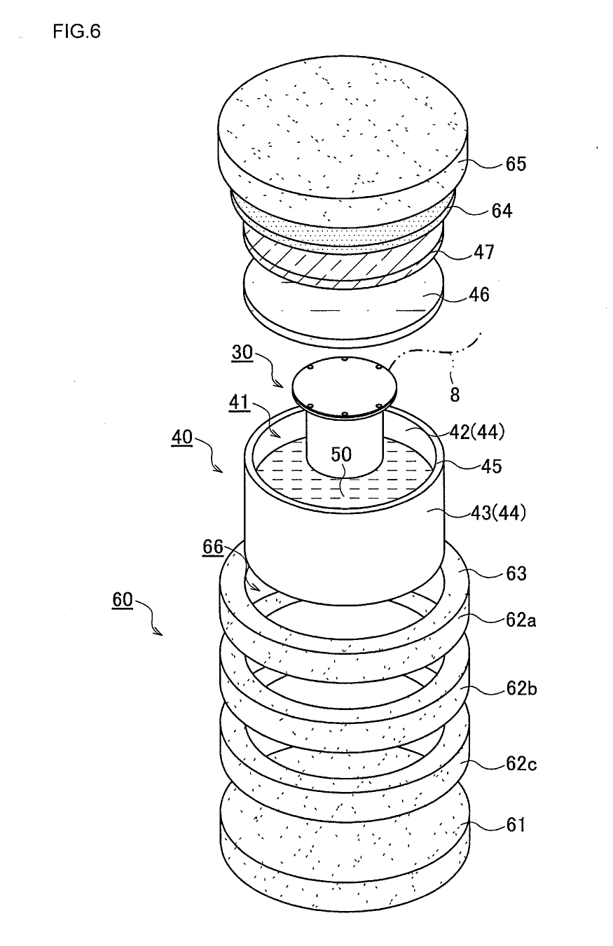

3. Temperature Measurement Device Next, description will be made as to the temperature measurement device 9 of one embodiment of the present invention which is for use in the temperature measurement method 1. As shown in FIG. 5 and FIG. 6, the temperature measurement device 9 of the present embodiment mainly includes temperature information recorders 20 electrically connected to the temperature sensors 8 attached to the honeycomb formed bodies 2 of the measuring targets, a sealed container 30 to store the temperature information recorders 20, a vacuum insulating container 40 configured to further store the sealed container 30, a refrigerant 50 to fill a periphery of the sealed container 30 stored in the vacuum insulating container 40, and a fire-resistant insulating container 60 configured to further store the vacuum insulating container 40.

Description will further specifically be made. Each temperature information recorder 20 is electrically connected to the temperature sensor 8 of the K-type thermocouple or the like, receives the sensor signal of the temperature sensor 8 to acquire the temperature information TI, and has a function of so-called “data logger”, and a commercially available data logger is usable. Consequently, the temperature information recorder can store and keep the acquired temperature information TI together with the time information concerned with the time elapsed after the temperature measurement device is introduced inside from the inlet 6. It is to be noted that the temperature information recorders 20 are prepared in accordance with the number of the temperature sensors 8 to be attached to the honeycomb formed bodies 2, respectively. For example, in FIG. 5, 16 temperature information recorders 20 in total are prepared, and stored in a recorder storage space 32 formed in a sealed container main body 31 of the sealed container 30. A radio communicating section (not shown) such as WiFi (registered trademark) is disposed in the temperature information recorder 20, so that it is possible to acquire the temperature information TI from the temperature measurement device 9 which is being conveyed in the firing space 5, in real time.

The sealed container 30 further includes a sealed container lid portion 34 which closes an open end 33 opened in an upper surface of the sealed container main body 31. The sealed container lid portion 34 covers the open end 33 from the upside, and is fixed by using well-known fixing members (not shown) such as bolts, and consequently, the recorder storage space 32 can be brought into a liquid-tight state to the outside. In other words, a liquid or the like is prevented from passing between the recorder storage space 32 in the sealed container 30 and the outside of the sealed container. In consequence, even in a state where the sealed container 30 is immersed into the refrigerant 50, the liquid of the refrigerant 50 or the like does not penetrate the recorder storage space 32. Therefore, the temperature information recorders 20 do not directly come in contact with the refrigerant 50. It is to be noted that there are not any special restrictions on a structure of the sealed container main body 31 and the sealed container lid portion 34, but each of these components is made of a metal material such as stainless steel. Furthermore, when the open end 33 is closed with the sealed container lid portion 34, a part of the temperature sensor 8 extending from the temperature information recorder 20 is sandwiched between the sealed container lid portion 34 and the sealed container main body 31. Also in this case, the liquid-tight state is held.

The sealed container 30 in which the temperature information recorders 20 are stored is further stored in a sealed container storage space 41 formed in the vacuum insulating container 40. The sealed container storage space 41 is formed in a size larger than that of the sealed container 30 so that the space is configured to store the sealed container 30, and the sealed container storage space 41 is filled with the refrigerant 50.

Therefore, when the sealed container 30 is stored in the sealed container storage space 41, the periphery of the sealed container 30 is filled with the refrigerant 50. There are not any special restrictions on the refrigerant 50, but the refrigerant may be water, ice water, dry ice or the like. The refrigerant 50 can prevent a temperature of the sealed container 30 and a temperature of the temperature information recorder 20 in the sealed container from being heightened.

Description will further specifically be made as to the vacuum insulating container 40. The vacuum insulating container includes a vacuum insulating container main body 44 including an outer shell wall 42 and an inner shell wall 43, having a vacuum insulating layer (not shown) between the outer shell wall 42 and the inner shell wall 43, and including the sealed container storage space 41 therein, and a rubber lid 46 and a stainless steel lid 47 which close an open end 45 of the vacuum insulating container main body 44 opened upward.

According to the above structure, heat transferred from the outside is cut off by the vacuum insulating layer. Furthermore, the refrigerant 50 filled in the sealed container storage space 41 cuts off the transfer of heat to the sealed container 30 and the temperature information recorders 20 stored in this sealed container. Consequently, the temperature information recorders 20 are not exposed to the high temperature. As a result, the temperature information recorders 20 do not cause failure and the like due to the high temperature.

Furthermore, in addition to the above structure, the temperature measurement device 9 of the present embodiment includes the fire-resistant insulating container 60 made of a fire-resistant insulating material and having a vacuum insulating container storage space 66 to store the vacuum insulating container 40. Here, the fire-resistant insulating container 60 includes a substantially disc-shaped insulating container base portion 61 which is mainly made of a ceramic material, e.g., firebricks and on which the vacuum insulating container 40 is disposed, to support the vacuum insulating container from the downside, a plurality of annular insulating container side portions 62a, 62b and 62c made of the same material as in the insulating container base portion 61 and stacked on one another, a paper-like thin ceramic sheet 64 which covers an upper surface portion 63 of the insulating container side portion 62a positioned at an uppermost stage, and an insulating container lid portion 65 possessing a substantially disc shape. Consequently, the vacuum insulating container storage space 66 is formed, and the vacuum insulating container 40 can be stored. At this time, the ceramic sheet 64 is sandwiched between the upper surface portion 63 of the insulating container side portion 62a and the insulating container lid portion 65.

In addition to the above structure, in the temperature measurement device 9 of the present embodiment, a metal sheet or the like made of a stainless steel foil and superimposed on the ceramic sheet 64 and its upper layer may be disposed to further cover the whole fire-resistant insulating container 60. Alternatively, the whole temperature measurement device 9 may be put in a basket (not shown) made of stainless steel and introduced into the firing space 5.

As described above, according to the temperature measurement method 1 of the present embodiment, the temperature measurement device 9 which stores and keeps the temperature information TI concerned with the formed body temperature of the inner portion of the honeycomb formed body 2 during the firing of the honeycomb formed body 2, especially during the removal of the binder can easily and immediately be collected from the take-out port 11 disposed in the middle of the temperature rise region R1 of the firing space 5. As a result, unlike the conventional insulating container system, it is not necessary to reverse the conveying direction A of the honeycomb formed body 2, and a firing efficiency of the honeycomb formed body 2 does not deteriorate.

Additionally, the heretofore well known K-type thermocouple is usable as the temperature sensor 8 for use. In place of the R-type thermocouple having a large diameter of several mm or more, the thermocouple having a diameter of about 0.5 mm is usable, an operation of attaching and detaching the temperature sensor 8 is therefore facilitated, and an operation efficiency improves. Furthermore, due to the use of the thermocouple (the K-type thermocouple) having a small diameter, the thermocouple can be attached to any region to which it has heretofore been difficult to attach the thermocouple, and a precise formed body temperature can be grasped.

Furthermore, the thermocouples are less intertwined, each thermocouple is less short-circuited in its middle, and it is possible to effectively prevent malfunctions and wrong operations. Additionally, it is possible to shorten an operation time, and the operators can proceed with the temperature measurement operation in a suitable operation environment. Furthermore, due to the above structure, it is possible to minimize an occupied space for the temperature measurement in the firing space 5, and it is possible to decrease influences on productivity. In addition, the formed body temperature of the inner portion of the honeycomb formed body 2 is precisely recordable along time series.

According to a temperature measurement method of a honeycomb formed body of the present invention and a temperature measurement device, it is possible to precisely acquire temperature information concerned with a formed body temperature of an inner portion of the honeycomb formed body in a firing step, together with its change with elapse of time, without deteriorating a firing efficiency of the honeycomb formed body, and the present invention is utilized especially beneficially in a manufacturing method of a honeycomb structure.

### DESCRIPTION OF REFERENCE NUMERALS

1: temperature measurement method (the temperature measurement method of a honeycomb formed body), 2: honeycomb formed body (of a measuring target), 2a: honeycomb formed body (of the firing target), 2b: one end face, 2c: the other end face, 3: honeycomb fired body, 4: continuous firing kiln, 5: firing space, 6: inlet, 7: outlet, 8: temperature sensor, 8a: measurement point, 9: temperature measurement device, 10: shelf plate, 11: take-out port, 12: sensor insertion hole, 12a: hole end, 13: stacked honeycomb formed body (of the measuring target), 13a: upper stage side honeycomb formed body, 13b: lower stage side honeycomb formed body, 13c: the other formed body end face, 13d: one formed body end face, 13e: stacked honeycomb formed body (of the firing target), 20: temperature information recorder, 30: sealed container, 31: sealed container main body, 32: recorder storage space, 33 and 45: open end, 34: sealed container lid portion, 40: vacuum insulating container, 41: sealed container storage space, 42: outer shell wall, 43: inner shell wall, 44: vacuum insulating container main body, 46: rubber lid, 47: stainless steel lid, 50: refrigerant, 60: fire-resistant insulating container, 61: insulating container base portion, 62a, 62b and 62c: insulating container side portion, 63: upper surface portion, 64: ceramic sheet, 65: insulating container lid portion, 66: vacuum insulating container storage space, A: conveying direction, R1: temperature rise region, R2: firing region, R3: cooling region, S1: temperature sensor attaching step, S1a: sensor insertion hole piercing step, S1b: temperature sensor inserting step, S2: introducing step, S3: temperature measuring step, S4: collecting step, S5: temperature information extracting step, S6: temperature information receiving step, and TI: temperature information.

What is claimed is:

1. A temperature measurement method of a honeycomb formed body in which a continuous firing kiln including a firing space constructed in an elongated tunnel shape and an inlet and an outlet each communicating with the firing space is utilized to measure a formed body temperature of the honeycomb formed body fired while being conveyed from the inlet toward the outlet,
the temperature measurement method comprising:
a temperature sensor attaching step of attaching a temperature sensor to the honeycomb formed body that is a measuring target,
an introducing step of mounting, on a shelf plate, the honeycomb formed body to which the temperature sensor is attached, and a temperature measurement device which receives a sensor signal from the temperature sensor to acquire temperature information of the formed body temperature, and introducing the shelf plate on which the honeycomb formed body and the temperature measurement device are mounted, from the inlet into the firing space,
a temperature measuring step of acquiring the temperature information of an inner portion of the honeycomb formed body conveyed and fired in the firing space, by the temperature measurement device conveyed together with the honeycomb formed body, and
a collecting step of collecting the temperature sensor and the temperature measurement device from a take-out port disposed in a middle of the firing space of the continuous firing kiln.

2. The temperature measurement method of the honeycomb formed body according to claim 1,
wherein the take-out port is disposed in a middle of a temperature rise region where a kiln temperature of the firing space is 500° C. or less.

3. The temperature measurement method of the honeycomb formed body according to claim 1, further comprising:
a temperature information extracting step of extracting the temperature information from the temperature measurement device collected in the collecting step.

4. The temperature measurement method of the honeycomb formed body according to claim 1,
wherein the temperature measurement device has a radio communication function of transmitting the acquired temperature information from the firing space to the outside of the continuous firing kiln,
the temperature measurement method further comprising:
a temperature information receiving step of receiving the transmitted temperature information outside the continuous firing kiln.

5. The temperature measurement method of the honeycomb formed body according to claim 1,
wherein the collecting step is performed in a state where the conveyance of the honeycomb formed body from the inlet toward the outlet is continued.

6. The temperature measurement method of the honeycomb formed body according to claim 1,
wherein the temperature sensor is a K-type thermocouple.

7. The temperature measurement method of the honeycomb formed body according to claim 1,
wherein the temperature sensor attaching step further comprises:
a sensor insertion hole piercing step of piercing a sensor insertion hole into which the temperature sensor of the honeycomb formed body of the measuring target is to be inserted, and
a temperature sensor inserting step of inserting the temperature sensor into the pierced sensor insertion hole and setting the temperature sensor so that a measurement point of the temperature sensor is positioned at the inner portion of the honeycomb formed body.

8. The temperature measurement method of the honeycomb formed body according to claim 7,
wherein in the sensor insertion hole piercing step, the sensor insertion hole is pierced to extend through an upper stage side honeycomb formed body of a stacked honeycomb formed body in which at least two honeycomb formed bodies are vertically stacked and to reach an inner portion of a lower stage side honeycomb formed body, and
in the temperature sensor inserting step, the temperature sensor is set so that the temperature sensor passes through the sensor insertion hole of the upper stage side honeycomb formed body and so that the measurement point of the temperature sensor is positioned at the inner portion of the lower stage side honeycomb formed body.

9. A temperature measurement device for use in the temperature measurement method of the honeycomb formed body according to claim 1, comprising:
a temperature information recorder electrically connected to a temperature sensor attached to the honeycomb formed body of a measuring target, to receive a sensor signal from the temperature sensor and to acquire temperature information of a formed body temperature of the honeycomb formed body,
a sealed container comprising a recorder storage space to store at least one temperature information recorder and configured to store the temperature information recorder in the recorder storage space while holding a liquid-tight state of the temperature information recorder,
a vacuum insulating container comprising a sealed container storage space configured to store the sealed container,
a refrigerant to fill a periphery of the sealed container stored in the sealed container storage space of the vacuum insulating container, and
a fire-resistant insulating container made of a fire-resistant insulating material and having a vacuum insulating container storage space configured to store the vacuum insulating container.

10. The temperature measurement device according to claim 9,
wherein the temperature information recorder further has a radio communicating section which transmits the acquired temperature information.
